(19) United States
(12) Patent Application Publication
(10) Pub. No.: US 2017/0307775 A1
(43) Pub. Date: Oct. 26, 2017

(54) SYSTEM AND METHOD FOR ADJUSTING THE ROPE SPREAD OF SEISMIC STREAMERS

(71) Applicant: CGG SERVICES SAS, Massy Cedex (FR)

(72) Inventors: Camille LAPIERRE, Jar (NO); Frederic SIMONNOT, Oslo (NO)

(21) Appl. No.: 15/521,324

(22) PCT Filed: Nov. 5, 2015
(86) PCT No.: PCT/IB2015/002440

§ 371 Date: Apr. 24, 2017

Related U.S. Application Data
(60) Provisional application No. 62/076,552, filed on Nov. 7, 2014.

(51) Int. Cl. G01V 1/38; B63B 21/66

(52) U.S. Cl. CPC G01V 1/3826; B63B 21/66

(57) ABSTRACT

A seismic survey system includes a set of streamers coupled via lead-in cables to a towing vessel. An active adjustment system adjusts a distance separating at least two of the streamers of the set of streamers from each other. The active adjustment system can include a rope attached to a winch or can include a set of wings.

### CROSS REFERENCE TO RELATED APPLICATIONS

This application claims priority and benefit from U.S. Provisional Patent Application No. 62/076,552, filed on Nov. 7, 2014, for “Adjustable Central Spread Rope,” the entire content of which is incorporated in its entirety herein by reference.

### BACKGROUND

### Technical Field

Embodiments of the subject matter disclosed herein generally relate to adjusting the distance between seismic streamers. More specifically, the embodiments relate to actively adjusting the distance separating two individual seismic streamers from each other.

### Discussion of the Background

Seismic data acquisition and processing generate a profile (image) of geophysical structures under seafloor or subsoil by emitting waves towards the seafloor and receiving and processing the reflections. FIG. 1 is a schematic diagram of a seismic survey system 100 used for seismic data acquisition. The system includes a survey vessel 102, which tows a plurality of streamers 104, each having one or more receivers 106 for receiving reflections from the surveyed area. The streamers 104 are coupled to the survey vessel 102 by front-end gear, which includes a plurality of lead-in cables 108. Spacer lines 110 laterally couple adjacent lead-in cables 108 to each other and are designed to prevent the distance between adjacent streamers from exceeding a desired distance. The lead-in cables 108 extend beyond the spacer lines 110 and include a float 112 to lift the lead-in cables 108 to an intended depth. Wings 114 are connected to the outermost lead-in cables to achieve parallel trajectories for the streamers 104 in the towing direction and also to achieve a desired separation 116 between the center-most lead-in cables 108_{c}, which is commonly referred to as the middle rope spread. As illustrated by dashed line 118 bisecting the vessel, the lead-in cables 108 and streamers 104 are separated by distance 116 into two sets, a port-side set of lead-in cables 108 and streamers 104 and a starboard-side set of lead-in cables 108 and streamers 104. Further, as also illustrated by dashed line 118, the sets of lead-in cables 108 and streamers 104 are ideally relatively evenly spaced from the centerline of the vessel 102. It will be recognized that a seismic system will include other elements in addition to those illustrated, including source element array.

Seismic systems must contend with disturbances, such as currents, and any fluctuations in the towed streamers directly affects the separation 116 between the two center-most streamers 108_{c}, which affects the quality of the data collected during the survey. One way of addressing these disturbances is to increase the rigidity of the system using a fixed length rope attached to the center-most lead-in cables 108c using sliders so that the ends of the fixed length rope slide along the center-most lead-in cables 108c.

Although the use of fixed length ropes increases the rigidity of the system and can stabilize the separation between the port and starboard side streamer arrays, there are a number of drawbacks to this arrangement. The fixed length ropes may make the system too rigid to deal with harsh boundary conditions, such as vessel turning, bad weather, rough currents, etc. Further, the fixed length rope can break under certain conditions and damage surrounding equipment, which can be quite costly to repair and could require early termination of a survey. Additionally, once the fixed length rope is deployed it cannot be recovered on board the vessel if it is broken, damaged, or is the incorrect length. The fixed length rope can also result in unsafe conditions when recovering/stacking the streamers at the end of the survey.

Accordingly, it would be desirable to provide devices, systems and methods to actively adjust the spread between two streamers while avoiding the afore-described problems and drawbacks.

### SUMMARY

According to an embodiment an active adjustment system is provided to adjust the distance separating seismic streamers from each other. The active adjustment system can include a winch that adjusts the payout of a rope coupled between the seismic streamers or can include wings arranged between the seismic streamers.

According to one embodiment a marine seismic survey system includes a set of lead-in cables coupled to a set of streamers. A first and second lead-in cable of the set of lead-in cables is respectively coupled to a first and second streamer of the set of streamers. The system also includes an active adjustment system coupled to the first and second lead-in cables or to the first and second streamers and configured to actively adjust a distance separating the first and second streamers from each other.

According to another embodiment, a marine seismic survey system includes a set of lead-in cables including a first and second lead-in cable, each of which includes a first end configured for coupling to a towing vessel. The system also includes a set of streamers including first and second streamers, each of which is respectively coupled to a second end of the first and second lead-in cables. An adjustable length spacer line couples the first and second lead-in cables to each other or couples the first and second streamers to each other and is configured to adjust a distance between the first and second streamers.

According to a further embodiment there is a method for adjusting spacing of marine seismic equipment. The method involves a vessel towing a set of streamers, which is coupled to the vessel via a set of lead-in cables. A separation between at least two streamers of the set of streamers is actively adjusted using an adjustable length spacer line coupling the at least two streamers to each other or coupling at least two lead-in cables of the set of lead-in cables to each other.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a seismic survey system used for seismic data acquisition;

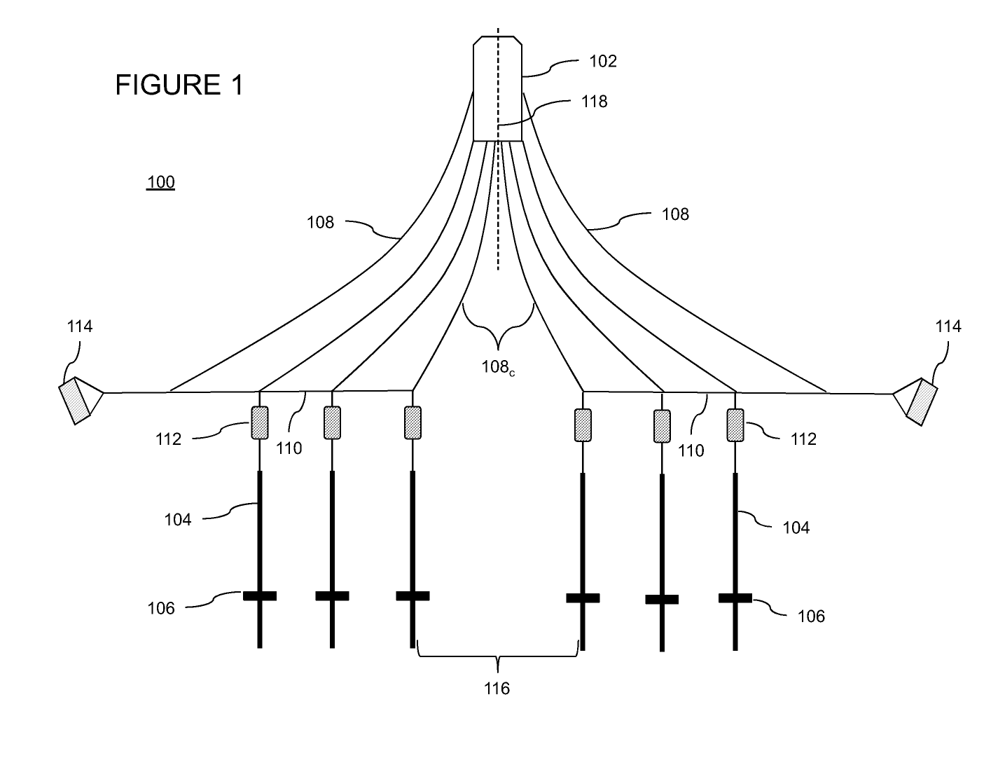

FIG. 2 is a schematic diagram of a seismic survey system with an active rope spread adjustment system according to an embodiment;

FIG. 3 is a schematic diagram of a seismic survey system with an active rope spread adjustment system according to another embodiment;

FIG. 4 is a schematic diagram of a seismic survey system with an active rope spread adjustment system according to yet another embodiment;

FIG. 5 is a schematic diagram of a seismic survey system with an active rope spread adjustment system according to a further embodiment;

FIG. 6 is a flowchart of a method for actively adjusting the rope spread; and

FIG. 7 is a schematic diagram of a control system.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed with regard to the terminology and structure of marine seismic survey equipment. However, the embodiments to be discussed next are not limited to marine seismic survey equipment, but may be applied in any application where it is desired to actively adjust the distance separating towed equipment.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to embodiments described in more detail below, stability of front-end equipment is improved using a system that actively adjusts the distance separating streamers from each other. According to one embodiment the active adjustment system can include a rope, the length of which can be actively adjusted to maintain a desired spread between two streamers. According to another embodiment the active adjustment system can include a set of wings coupled to two lead-in cables and/or two streamers.

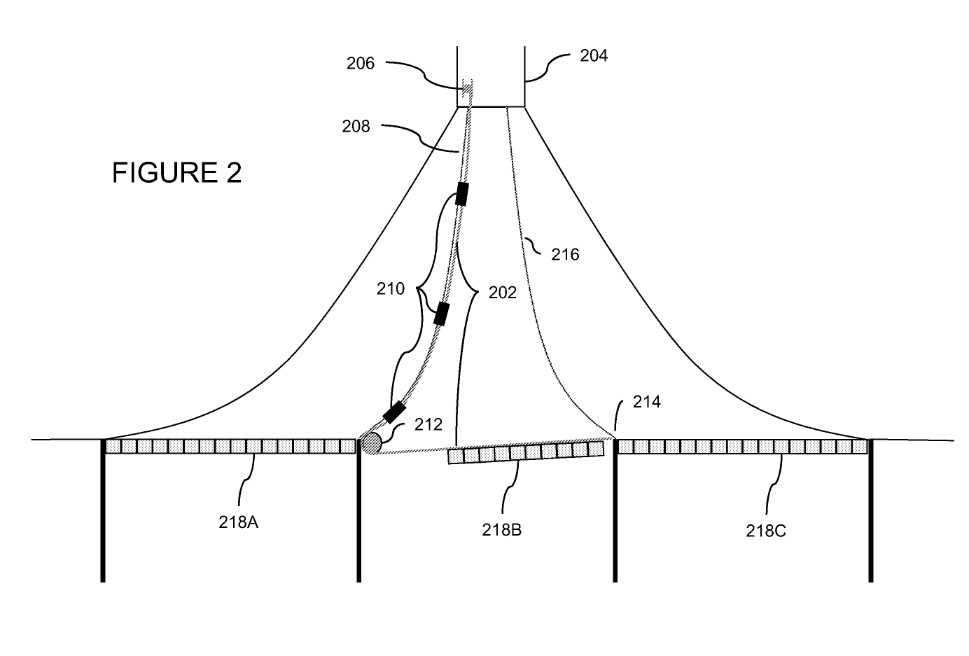

FIG. 2 is a schematic diagram of a seismic survey system with an active rope spread adjustment system according to an embodiment. In this embodiment the active adjustment system includes a rope 202, one end of which is attached to a winch 206, which in turn is attached to vessel 204. The rope 202 is attached to one of the center-most lead-in cables 208 (the port-side one in the illustrated example) by one or more guides 210, which in addition to guiding the rope 202 also avoids the rope from interfering with the source array (not illustrated). The guides 210 can be clamped around the lead-in cable 208 and also be removable during recovery of the equipment. The rope 202 passes through a pulley 212, which is attached to center-most lead-in cable 208 and then terminates at an attachment point 214 of the other of the center-most lead-in cables 216 (the starboard-side one in the illustrated example). Alternatively, the pulley 212 and/or the attachment point 214 can be attached to the streamers, in which case the lead-in cables terminate in the area of the spread ropes. The pulley 212 can be adapted to account for any hangers on the lines with a trumpet-shaped entry to reduce the risk of jamming. Attachment point 214 can be configured as one that automatically releases under a certain amount of force (e.g., a hook) so that the rope 202 can be released in case of rough conditions and also to ease recovery of the streamers. Alternatively, the attachment point 214 can be a manually released attachment point, in which case it is still possible to remove the rope by picking up the lead-in with the attachment point first while paying the rope out of the winch, and the manually detaching the rope at the point of attachment.

As illustrated in FIG. 2, the spacer ropes between the streamers are covered in foil fairings 218A and 218C, which reduce drag. In order to allow adjustment of the length of the rope 202 without interfering with the operation of pulley 212, only a portion of the rope 202 between the two center-most lead-in cables 208 and 216 is covered with a foil fairing 218C.

The adjustable length rope in the embodiment of FIG. 2, as well as the embodiments below, increases the rigidity of the system while providing a number of advantages compared to the use of a fixed length rope. The adjustable length rope allows for slackening of the system when turning or in bad weather, thereby reducing the stress on the system during these conditions. Adjusting the rope length also allows the spread between the two streamer arrays to be adjusted to meet contractual specification for a particular survey based on the environment specification. Further, if the rope is broken it can be recovered on board the vessel. Although FIG. 2 illustrates rope 202 traveling along the port-side center-most lead-in cable 208, the rope can alternatively travel along the starboard-side center-most lead-in cable 216.

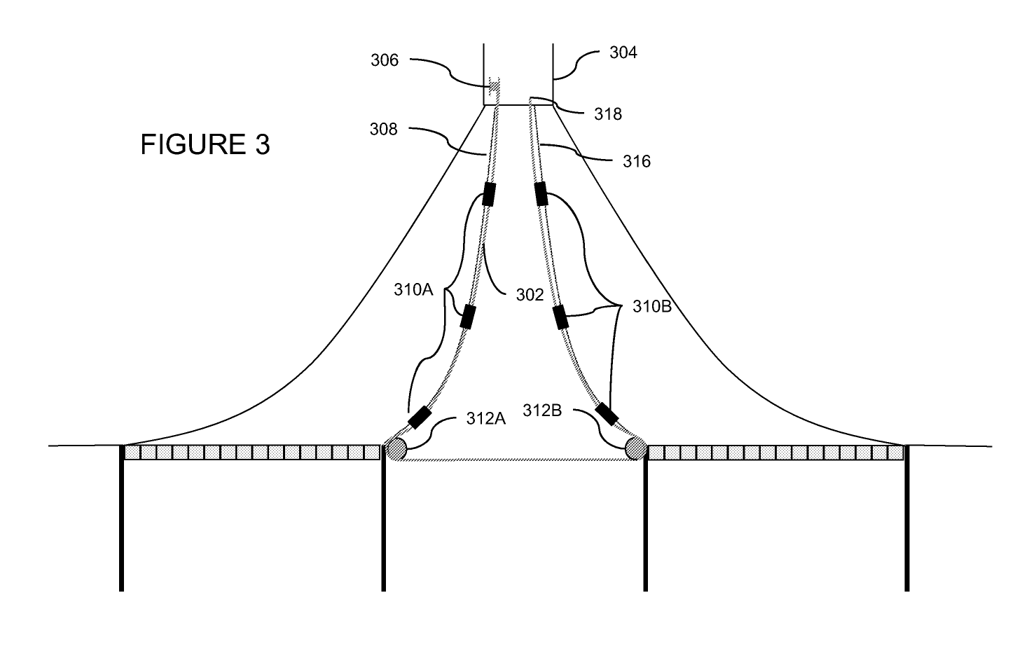

FIG. 3 is a schematic diagram of a seismic survey system with an active rope spread adjustment system according to another embodiment. In contrast to the embodiment of FIG. 2, in the embodiment of FIG. 3 both ends of rope 302 are coupled to the towing vessel 304. Specifically, a first end of the rope 302 is coupled to the winch 306 and the rope then passes along lead-in 308, where it is connected by guides 310A. The rope then passes through pulley 312A, which is attached to lead-in 308, and through pulley 312B, which is attached to lead-in 316. Alternatively, the pulley 312A and/or 312B can be attached to the streamers. The rope 302 then passes along lead-in 316, where it is coupled by guides 310B, and then terminates at attachment point 318 on vessel 304. Similar to the embodiment of FIG. 2, the attachment point 318 can be one that automatically releases under a certain amount of force, one that is manually releasable, or one that is a fixed point as described above. Although FIG. 3 illustrates the winch 306 being located on the port-side and the attachment point 318 being located on the starboard-side, this can be reversed so that the winch 306 is on the starboard side, the rope 302 first passes along the starboard-side center-most lead-in 316, then along the port-side center-most lead-in 308, and then terminates at a attachment point 318 on the port-side of the vessel 304.

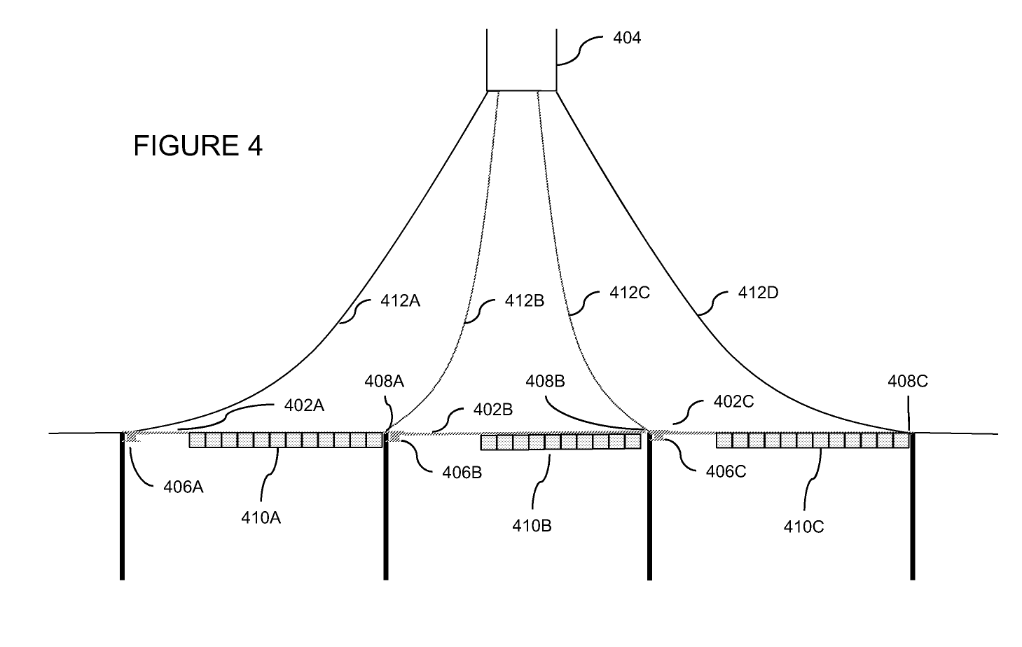

FIG. 4 is a schematic diagram of a seismic survey system with an active rope spread adjustment system according to yet another embodiment. In contrast to the embodiments of FIGS. 2 and 3, in the embodiment of FIG. 4 the active adjustment system is not coupled directly to the vessel 404. Instead, the ropes 402A-402C are coupled between the lead-in cables 412A-412D and streamers. Specifically, rope 402A is attached on one end to winch 406A and at the other end to attachment point 408A; rope 402B is attached on one end to winch 406B and at the other end to attachment point 408B; and rope 402C is attached on one end to winch 406C and at the other end to attachment point 408C. The winches 406A-406C and the attachment points 408A-408C can be attached to the lead-in cables 412A-412D and/or to the streamers. The winches 406A-406C can be arranged below the head floats or at any or connection point or bend restrictor point. The winches 406A-406C can receive electrical power from the vessel 404 via one of the lead-in cables 412A-412D, from a battery, and/or a combination of battery power and another generator (e.g., hydro-power generator, solar power generator, etc.). Control of winches 406A-406C from the vessel 404 can be via a radio link, acoustic link, and/or a wire that is part of one of the lead-in cables 412A-412D.

In order to allow for the active adjustment of ropes 402A-402C, each of the ropes is covered only partially by a respective foil fairing 410A-410C. As in the previous embodiments, the attachment points 408A-408C can be ones that automatically release under a certain amount of force, ones that are manually releasable, or ones that are fixed points as described above. Alternatively, attachment points 408A and 408C can be fixed attachment points and attachment point 408B can be one that automatically releases under a certain amount of force. Although FIG. 4 illustrates active adjustment systems between a number of different streamers, this embodiment can also be implemented so that ropes 402A and 402C are fixed ropes, similar to the spacer ropes described above, and only rope 402B can be actively adjusted. In this case foil fairings 410A and 410C can cover the entirety of the ropes 402A and 402C and winches 406A and 406C can be omitted.

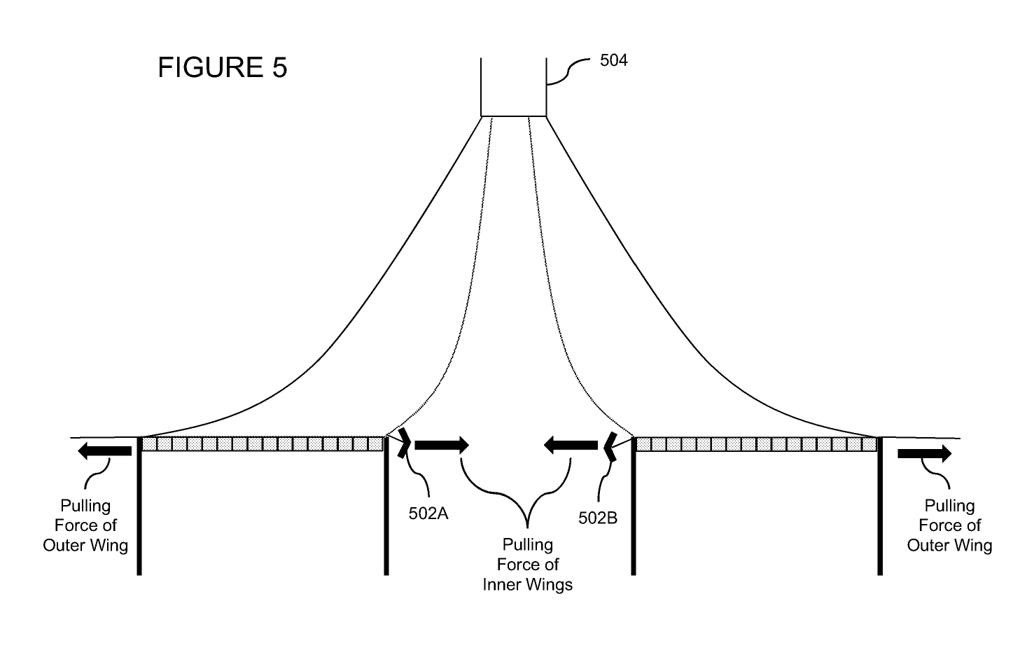

FIG. 5 is a schematic diagram of a seismic survey system with an active rope spread adjustment system according to a further embodiment. In contrast to the embodiments of FIGS. 2-4 where a rope is employed as part of the active adjustment system, in the embodiment of FIG. 5 wings 502A and 502B can be implemented as part of the active adjustment system. Specifically, as illustrated by the outermost arrows, the outermost wings (not illustrated) generate an outward force on the streamers and the innermost wings 502A and 502B generate an inward force toward a centerline between sets of streamers. The positioning of wings 502A and 502B can be adjusted using an actuator, such as an electrical rod, a winch, and the like, to adjust the distance separating the two sets of streamers. Control of the positioning of the wings 502A and 502B from the vessel 504 can be achieved using a radio link, acoustic link, and/or wires that are part of one of the lead-in cables. The wings 502A and 502B can be arranged under the inner head floats or bend restrictors, or on other lead-in cables. Alternatively the wings 502A and 502B can be coupled to the streamers. Although FIG. 5 illustrates using two inner wings 502A and 502B, more than two wings can be employed. This could involve some wings arranged to pull inwards and others arranged to pull outwards.

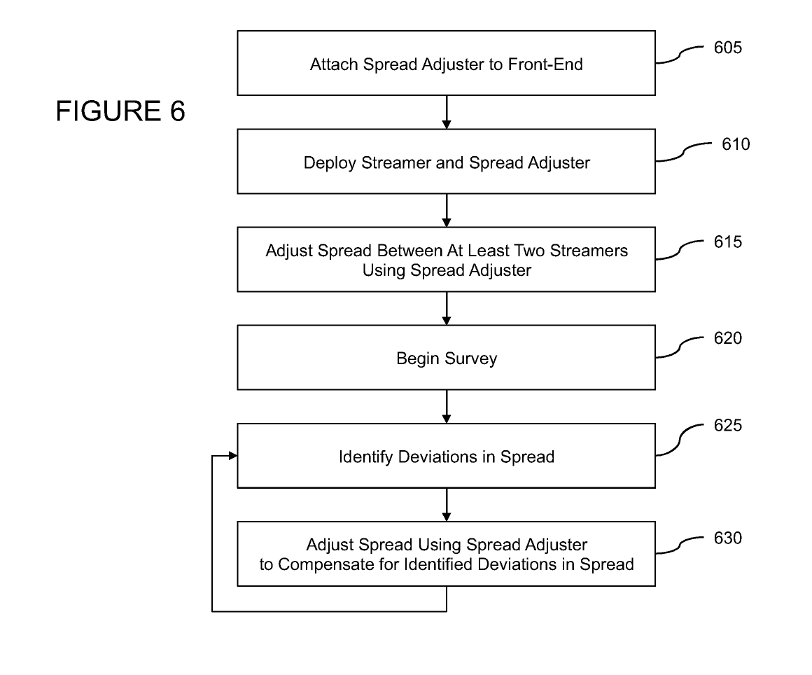

FIG. 6 is a flowchart of a method for actively adjusting the rope spread. The spread adjustment system is attached to the front-end according to any of the embodiments above (step 605) and the streamer and spread adjustment system are deployed into the water (step 610). The spread between at least two streamers is initially adjusted to a desired distance (step 615). Once the survey begins (step 620) any deviations in the spread are identified (step 625) and the spread adjustment system is adjusted to compensate for the identified deviations (step 630). It should be recognized that the desired length need not be a static, fixed length but can vary. For example, a desired length while traveling along a survey path can be different from a desired length when turning the vessel, in the latter case the desired length may be longer than when traveling along a survey path to allow slack in the system and avoid damage due to an overly rigid system.

The determination of the adjustment can be under automated control using a program that accounts for current data, such as vessel speed, streamer separation, and other navigation data. As discussed above, the spread adjustment system is an active system, and accordingly the flow returns to step 625 to continue to identify middle spread deviations and adjust for them in step 630.

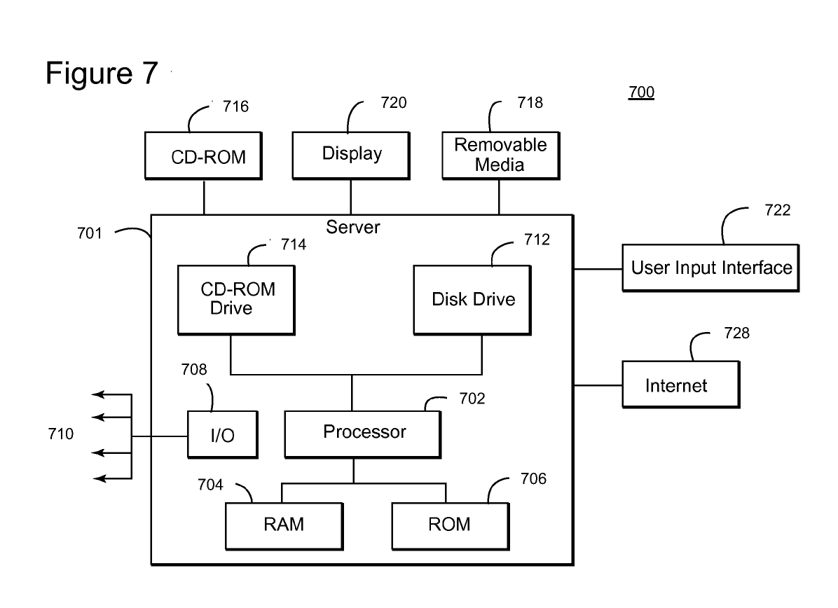

An example of a representative control system capable of carrying out operations in accordance with the exemplary embodiments discussed above is illustrated in FIG. 7. Hardware, firmware, software or a combination thereof may be used to perform the various steps and operations described herein.

The exemplary control system 700 suitable for performing the activities described in the above-noted embodiments may include server 701. Such a server 701 may include a central processor unit (CPU) 702 coupled to a random access memory (RAM) 704 and to a read-only memory (ROM) 706. ROM 706 may also be other types of storage media to store programs, such as programmable ROM (PROM), erasable PROM (EPROM), etc. Processor 702 may communicate with other internal and external components through input/output (I/O) circuitry 708 and bussing 710, to provide control signals and the like. For example, processor 702 may communicate with the sensors, electro-magnetic actuator system and/or the pressure mechanism of the source element. Processor 702 carries out a variety of functions as are known in the art, as dictated by software and/or firmware instructions.

Server 701 may also include one or more data storage devices, including hard and disk drives 712, CD-ROM drives 714, and other hardware capable of reading and/or storing information, such as a DVD, etc. In one embodiment, software for carrying out the above-discussed steps may be stored and distributed on a CD-ROM 716, removable media 718 or other form of media capable of portably storing information. These storage media may be inserted into, and read by, devices such as the CD-ROM drive 714, the disk drive 712, etc. Server 701 may be coupled to a display 720, which may be any type of known display or presentation screen, such as LCD, plasma displays, cathode ray tubes (CRT), etc. A user input interface 722 is provided, including one or more user interface mechanisms such as a mouse, keyboard, microphone, touch pad, touch screen, voice-recognition system, etc.

Server 701 may be coupled to other computing devices, such as the equipment of a vessel, via a network. The server may be part of a larger network configuration as in a global area network (GAN) such as the Internet 728, which allows ultimate connection to the various landline and/or mobile client/watcher devices.

As also will be appreciated by one skilled in the art, the embodiments of the method may be performed using instructions stored on a non-transitory computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

The disclosed exemplary embodiments provide an active adjustment system to adjust the distance separating two streamers from each other. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A marine seismic survey system, comprising:
a set of lead-in cables coupled to a set of streamers, wherein a first and second lead-in cable of the set of lead-in cables are respectively coupled to a first and second streamer of the set of streamers;
an active adjustment system coupled to the first and second lead-in cables or to the first and second streamers and configured to actively adjust a distance separating the first and second streamers from each other.

2. The marine seismic survey system of claim 1, wherein
the set of lead-in cables includes a first and second set of lead-in cables,
the set of streamers includes a first and second set of streamers,
the first streamer is part of the first set of streamers and is a streamer that is closest to the second set of streamers among streamers of the first set of streamers,
the second streamer is part of the second set of streamers and is a streamer closest to the first set of streamers among streamers of the second set of streamers,
the first lead-in cable is part of the first set of lead-in cables and is a lead-in cable that is closest to the second set of lead-in cables among lead-in cables of the first set of lead-in cables, and
the second lead-in cable is part of the second set of lead-in cables and is a lead-in cable closest to the first set of lead-in cables among lead-in cables of the second set of lead-in cables.

3. The marine seismic survey system of claim 2, wherein
the active adjustment system comprises a winch and a rope,
the winch is carried on a vessel, which is coupled to the first and second sets of lead-in cables,
the rope passes from the winch along the first lead-in cable to a pulley.

4. The marine seismic survey system of claim 3, wherein the rope passes from the pulley and terminates at an attachment point coupled to the second lead-in cable or the second streamer.

5. The marine seismic survey system of claim 3, wherein the rope passes from the pulley to another pulley and then terminates on the vessel.

6. The marine seismic survey system of claim 1, wherein
the set of lead-in cables includes a first and second set of lead-in cables,
the first and second lead-in cables are part of the first set of lead-in cables,
the set of streamers includes a first and second set of streamers,
the first and second streamers are part of the first set of streamers,
the active adjustment system comprises a winch and a rope,
the winch is coupled to the first lead-in cable or the first streamer, and
the rope passes from the winch and terminates on the second lead-in cable or the second streamer.

7. The marine seismic survey system of claim 2, wherein
the active adjustment system comprises a winch and a rope,
the winch is coupled to the first lead-in cable or the first streamer, and
the rope passes from the winch and terminates on the second lead-in cable or the second streamer.

8. The marine seismic survey system of claim 2, wherein the active adjustment system comprises at least two wings, each of which is coupled to one of the first and second lead-in cables or to one of the first and second streamers and each of which is arranged between the first and second lead-in cable or between the first and second streamers.

9. A marine seismic survey system, comprising:
a set of lead-in cables including a first and second lead-in cable, each of which includes a first end configured for coupling to a towing vessel;
a set of streamers including first and second streamers, each of which is respectively coupled to a second end of the first and second lead-in cables; and
an adjustable length spacer line coupling the first and second lead-in cables to each other or coupling the first and second streamers to each other and configured to adjust a distance between the first and second streamers.

10. The marine seismic survey system of claim 9, wherein
the set of lead-in cables includes a first and second set of lead-in cables,
the set of streamers includes a first and second set of streamers,
the first lead-in cable is part of the first set of lead-in cables and is a lead-in cable closest to the second set of lead-in cables among lead-in cables of the first set of lead-in cables,
a second lead-in cables is part of the second set of lead-in cables and is a lead-in cable closest to the first set of lead-in cables among lead-in cables of the second set of lead-in cables,
the first streamer is part of the first set of streamers and is a streamer closest to the second set of streamers among streamers of the first set of streamer, and
the second streamer is part of the second set of streamers and is a streamer closest to the first set of streamers among streamers of the second set of streamers.

11. The marine seismic survey system of claim 10, wherein
the towing vessel includes a winch,
a pulley is coupled to the first streamer or to the first lead-in cable,
the adjustable length spacer line is coupled to the winch and to the pulley, and
the adjustable length spacer line runs from the winch, along the first lead-in cable, through the pulley, and terminates at the second lead-in cable or at the second streamer.

12. The marine seismic survey system of claim 11, wherein the first lead-in cable includes guides that guide the adjustable length spacer line from the towing vessel to the pulley.

13. The marine seismic survey system of claim 11, wherein the adjustable length spacer line terminates at a releasable attachment point on the second lead-in cable or on the second streamer.

14. The marine seismic survey system of claim 10, wherein
the towing vessel includes a winch,
a first pulley is coupled to the first lead-in cable or to the first streamer,
a second pulley is coupled to the second lead-in cable or to the second streamer, and
the adjustable length spacer line runs from the winch, through the first and second pulleys, and terminates at an attachment point on the towing vessel.

15. The marine seismic survey system of claim 14, wherein the first lead-in cable includes a first set of guides that guide the adjustable length spacer line from the towing vessel to the pulley and the second lead-in cable includes a second set of guides that guide the adjustable length spacer line from the another pulley to the towing vessel.

16. The marine seismic survey system of claim 9, wherein
the set of lead-in cables includes a first and second set of lead-in cables,
the set of streamers includes a first and second set of streamers,
the first and second lead-in cables are part of the first set of lead-in cables,
the first and second streamers are part of the first set of streamers,
a winch is coupled the first lead-in cable or to the first streamer, and
the adjustable length spacer line runs from the winch and terminates on the second lead-in cable or one the second streamer.

17. The marine seismic survey system of claim 10, further comprising a winch coupled to the first lead-in cable or to the first streamer, wherein the adjustable length spacer line runs from the winch and terminates on the second lead-in cable or the second streamer.

18. The marine seismic survey system of claim 9, wherein the adjustable length spacer line adjusts the distance between the first and second streamers to a first distance while the streamers are receiving reflections and to a second distance when the towing vessel is turning, wherein the first distance is less than the second distance.

19. A method for adjusting spacing of marine seismic equipment, comprising:
towing, by a vessel, a set of streamers, which is coupled to the vessel via a set of lead-in cables;
actively adjusting a distance between at least two streamers of the set of streamers using an adjustable length spacer line coupling the at least two streamers to each other or coupling at least two lead-in cables of the set of lead-in cables to each other.

20. The method of claim 19, wherein the adjustable length spacer line is adjusted to a first distance while the streamers are receiving reflections and to a second distance when the towing vessel is turning, wherein the first distance is less than the second distance.
